(19) United States
(12) Patent Application Publication
(10) Pub. No.: US 2009/0286609 A1
(43) Pub. Date: Nov. 19, 2009

(54) SKATEBOARD ARENA AND METHOD OF COMPETITION

(76) Inventor: Robert DYRDEK, Los Angeles, CA (US)

Correspondence Address: STEFAN KIRCHANSKI, VENABLE LLP 2049 CENTURY PARK EAST, 21ST FLOOR, LOS ANGELES, CA, 90067, US

(21) Appl. No.: 12/467,236

(22) Filed: May 15, 2009

Related U.S. Application Data
(60) Provisional application No. 61/053,655, filed on May 15, 2008.

(51) Int. Cl. A63C 19/00; G06F 19/00

(52) U.S. Cl. 472/89; 700/92; 472/92

(57) ABSTRACT

The present invention includes a skateboard arena simulating an urban landscape, comprising a course including a number of structures used for skateboarding tricks; and a mechanism for electronic real-time scoring of skateboarding tricks performed by a competitor during at least one run on the course. Each structure simulates a feature of an urban landscape. A method for a skateboard competition, comprises starting with a plurality of competitors in a qualifying round. Each competitor is electronically scored each in real-time based on tricks performed. The competitors for a final round are determined. The final round competitors are electronically scored in real-time based on tricks performed and a winner of the competition is declared.

### BACKGROUND OF THE INVENTION

1. Area of the Art

The present invention relates in general to a competition arena. More particularly, the present invention relates to a skateboard arena and competition format.

2. Description of the Background Art

Skateboarding involves a skateboarder (or skater or rider) riding on a skateboard and performing tricks with the skateboard. Action Sports is a category of recreation that encompasses more than 31.9 million participants in the US alone. Action sports products account for 27% of the estimated $45.5 billion sporting goods market, or about $12 billion in sales each year. The lion's share of this market is made up of skateboarders, with an estimated 13.3 million participants in America and 20 million worldwide. As a result, skateboarding makes up 42% of the US Action Sports market and therefore, skateboarding is the single most popular alternative to mainstream sports.

Interest in skateboarding has been growing for decades. What originally started as a method of fun transportation has evolved into a popular sport. Street skating developed when restless surfers were faced with calmed oceans and flat surf and sought to emulate the turning and carving sensation of surfing on land. The early skaters did this by fastening roller skates to the bottom of wood planks. These crude models eventually developed into better-designed skateboards with well-engineered aluminum “trucks” that fixed hard urethane wheels to the board.

Skateboarding started out in public streets, sidewalks and parking lots (both public and private). Eventually, these “sidewalk surfers” started carving and skating on natural embankments, man-made obstacles, and even began to drain swimming pools to skate in. As skateboarders developed skateboarding techniques and tricks for use on streets, sidewalks and parking lots, skateboarders also began experimenting with using the contoured surfaces and sides of empty swimming pools, ramps, drainage channels and the like to develop new types of tricks.

Importantly, 78% of all skateboarders identify themselves as “street skateboarders.” Street skateboarding, or street skating, literally means riding a skateboard in the street. While on residential and/or city streets, street skateboarders perform maneuvers on any number of obstacles or architecture that is commonly found in a natural environment. “Obstacles,” or “skate spots” as they are referred to by skaters, include, but are not limited to curbs, ledges, stairs, handrails, sidewalks, driveway bumps, fences, walls, embankments, planters, benches, picnic tables, manholes, loading docks and practically anything that exists in a natural or man-made environment (urban or suburban). This means the sport of skateboarding is overwhelmingly made up of participants who would much rather ride actual city streets and landscapes filled with obstacles (despite the fact that this is illegal in many jurisdiction) then ride in traditional skateboard rink that contain only ramps and lack any truly challenging features. An example of a conventional skatepark or skateboard rink is disclosed in U.S. Pat. No. 4,121,821. The huge disparity in preference is because street skating is driven by the skaters quest to do innovative tricks in real street environments or “skate spots” rather than the non-challenging environment of the conventional skateboard rink. These skate spots become landmarks in the there own right because skaters obtain notoriety from performing tricks on these difficult street obstacles. In fact, a skaters ability to document their tricks on these spots is one way to eventually become a professional skateboarder.

Over time, skateboarding went from amateur entertainment to a professional sport. Currently, skateboard contests are unorganized, and lack any understandable scoring system or performance statistics. Also, skateboard contests are largely avoided by the best skateboarding professionals and the core participant base because these contests are usually structured in an unexciting two-minute single skateboarder format, take place in unauthentic environments, and are judged without any regard to the spectator's understanding of the sport or the true innovative nature of street skateboarding. One of the biggest drawbacks to current skateboarding competitions is the lack of any real-time scoring feedback. Contestants may not find out how they scored during a competition until well after they completed their run or heat.

The huge distaste for traditional skateparks and ramp skating permeates deep into the street skating culture. It is for this reason that many skateparks are built and skaters hardly visit them. Importantly, this overwhelming preference for street skating negatively affects the current value that skateboard contests have in the sport. As mentioned above, the majority of professional skateboard contests are held at conventional skateparks that do not truly represent the type of terrain that the skaters enjoy (e.g., city-like obstacles). As a result, many problems arise including the contests not being representative of the environments that skaters like skating and enjoy watching. Since almost 74% of all skaters prefer skating street obstacles, the skaters do not relate to the spectatorship of skate events on non-city like courses. Another problem is the feeling, sound, and level of difficulty are completely distinctive in street environments than conventional skateparks. In their current design, the popularity of skateparks is greatly restricted. Yet another problem is that since the most respected, magnetizing, and highest paid professional skateboarders are street skaters, they are usually not active in professional skate contests. This is because these events do not include obstacles that speak to their tastes and abilities. Traditionally, it has been a much better use of their time for the professional street skaters to skate real street environments then participate in events that do not award true street skating ability or further their careers. In particular, traditional skate contests do not reward the progressive ability and innovation of pro skaters. Instead, traditional skate contests reward a mediocre consistency that is not respected in the world of street skating. In alienating the most popular professional skaters, skate contests in turn alienate the majority of street skaters from becoming a loyal and dedicated audience. Thus, a large number of core skateboarders do not want to watch a professional skateboard content and this restricts the professional street skateboarders from wanting to participate in the contests. Skateboarders are faced with a dilemma: ignore the illegality of skating places they love or submit to unsatisfactory conventional skateparks that do not meet their need for challenging obstacles.

In addition to the problems arising from the traditional skatepark contests, the overall judging and format of skate contests have various problems that must be addressed. As discussed, one problem is that current skate contests are either an unexciting two-minute individual “run” format or a chaotic “jam” format. The run format is based on allowing only one skater on the course for a period of time in order for them to try to land as many tricks in a row that he or she can. This results in the judge's natural bias towards consistency rather than exciting innovation. Furthermore, the overall dynamic of the individual run format lends itself to repetition of tricks and a static, non-exciting contest for the spectator. On the other hand, the jam format typically has skaters crashing into each other and allows for judges to miss some of the important tricks that are completed. The jam format tends to confuse the non-skating spectator and becomes too stressful for the professional to properly concentrate on the tricks they would like to accomplish in the event. Thus, scoring can be inconsistent and unpredictable.

As mentioned above, traditional scoring typically does not allow a skater to know where they stand in points and ranking until the end of their heat or perhaps only until the end of the event if it is a jam format. This prevents the skaters from knowing exactly what level of skating they need to put forth to win the event and restricts the spectator from knowing if certain skaters are “neck and neck” during the contest. This discourages any exciting build-up in the competition that could climax in a “buzzer-beating” moment separating first place from second place.

Accordingly, there is a need for an arena that provides features for a skateboard competition. There is a further need for a competition format that can be carried out in the arena. There is also a need for rules to guide the competition. There is a need for a competition format that simulates a street skating environment. There is an additional need for real-time scoring for a competition format. The present invention satisfies these needs and provides other related advantages.

### SUMMARY OF THE INVENTION

The present invention is useful in a variety of ways. In accordance with the present invention, a skateboard arena and method of competition for that arena are disclosed herein that totally revolutionize the skateboarding contest by providing a multi-skater lane-based format; using real-time allocation of points; and creating a statistical rating system to provide a magnetizing live-event for both the most seasoned skateboarder as well as a spectator who has never once stepped on a skateboard.

In accordance with the present invention, a revolutionary contest format, authentic street plaza design, and a scoring system are disclosed that solve the inadequacies of traditional skateboarding contests while simultaneously allowing for real-time understanding of all the complex and fast-moving tricks. In addition, the most popular alternative to mainstream sports will finally have more authentic street environments for people to skate, thereby helping to grow the sport and offer social value to each participating community.

In accordance with the present invention, a directional and one-at-a-time, multi-skater lane-based format is provided; thereby creating an exciting multi skater experience while preventing skaters from running into each other and allowing for viewers and judges to fully take in each skaters trick.

In accordance with the present invention, a sectional based contest, highlighting every area of street skateboarding, including but not limited to, technical “ledge” and “manual” skating, big gap skating, large stairs and handrail skating.

In accordance with the present invention, authentic city terrain is recreated through the use of smooth marble, city-like landscaping, and creative architectural design.

In accordance with the present invention, an invitation-only skateboarding contest event is provided for a limited number of the best professional skaters to try to compete into the Finals. Only the top ranked will be ensured an invitation to the following year's event. For example, out of thirty invited contestants, only those contestants who ranked in the top fifteen would be re-invited for the following year.

In accordance with the present invention, the contest could also provided creative prizes above and beyond traditional purse winnings. For example, prizes could include, without limitation, particular skaters being recognized for “trick of the year,” “section winner of the year,” “points leader of the year,” and much more.

Importantly, every decision regarding the competition format directly addresses the current issues street skaters have with skate contests. Specifically, the authenticity and city-like plaza ensures both street skaters and pro skaters feel comfortable and are excited to participate in the event. Also, the directional lane-based format ensures proper viewing of the skaters by the spectators and judges while preventing skaters from running into each other. Additionally, the invitation-only model ensures that the most entertaining, magnetizing, and important street skaters are in attendance. Finally, the instant, real-time scoring creates an experience of real-time understanding for the tricks, points allocated, and instant up-to-date ranking of each skater.

Other features and advantages of the invention will become more apparent from the following detailed description, taken in conjunction with the accompanying drawings which illustrate, by way of example, the principles of the invention.

### BRIEF DESCRIPTION OF THE FIGURES

The accompanying drawings illustrate the invention. In such drawings:

FIG. 1 illustrates a competition arena in accordance with an embodiment of the present invention;

FIG. 2 illustrates a plan view of a competition arena in accordance with another embodiment of the present invention;

FIG. 3 illustrates a competition arena in accordance with an additional embodiment of the present invention;

FIG. 4 illustrates a skateboarder's point of view from a competition lane in the competition arena of FIG. 3; and

FIG. 5 illustrates an angled view of a generally X-shaped skateboard obstacle in accordance with an embodiment of the present invention.

### DETAILED DESCRIPTION OF THE INVENTION

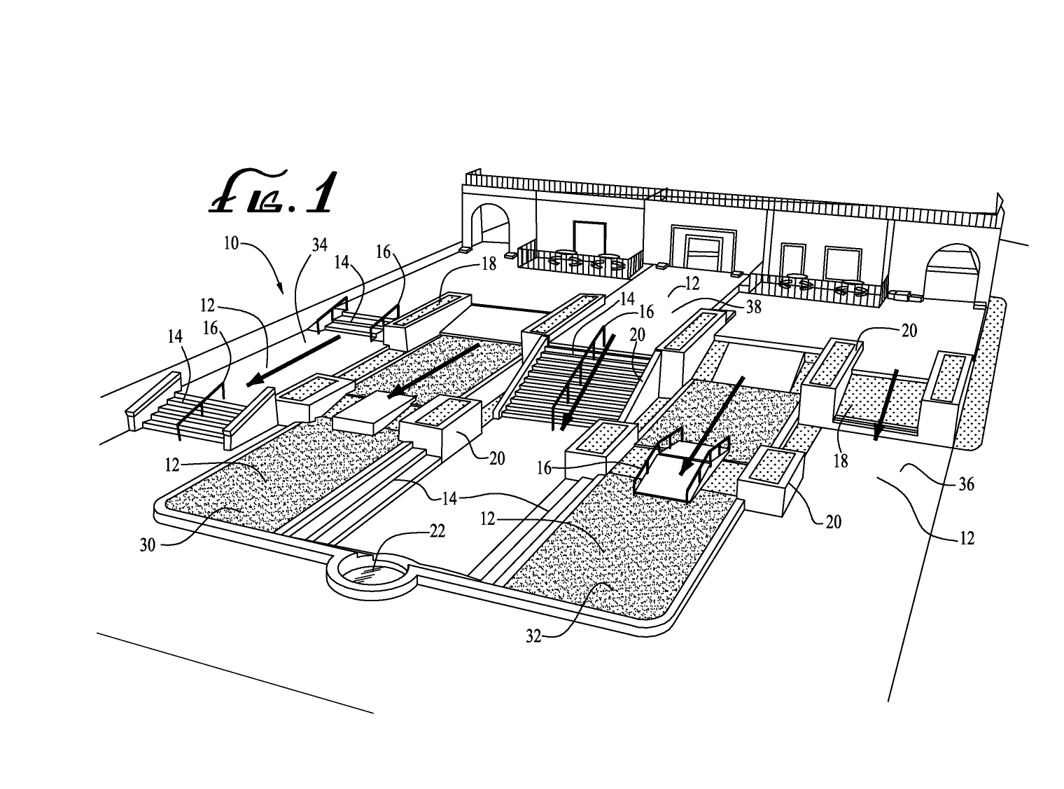

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide a skateboarding competition arena and a method of competition. As seen in FIG. 1, an illustrative skateboarding competition skate plaza or arena 10 in accordance with an embodiment of the present invention includes a course 12 comprising a number of distinct competition lanes 12. Five (5) lanes 12 are illustrated with each lane 12 corresponding to a distinct, skateboarding skill level although the number of lanes 12 may vary. The arena 10 simulates a number of environments (e.g., a street corner environment; a corner park environment; the environment outside of an office building that includes various obstacles that include, without limitation, steps (e.g., broad wide steps, short narrow steps, etc.) 14, handrails (e.g., metal railing, concrete or stone handrails, etc.) 16 with the handrails 16 on the sides of the steps 14 or running down the middle of the steps 14, trees (not shown), landscaping 18, concrete ledges 20, water fountains 22 or the like) that can be found in any urban or suburban area. The arena 10 gives the impression that a skateboard competitor is in a public square in a downtown area or on the steps outside city hall or a courthouse.

The characteristics that distinguish an arena (e.g., arena 10) from traditional skateparks include, without limitation, concrete (e.g., smooth, rough, etc.), metal, marble, wood, plastic, or fiberglass. While wood, plastic, or fiberglass may be used imitate real urban obstacles, it is preferred that smooth concrete and marble primarily be used to simulate the feel of an urban street environment. The materials and architecture combine to recreate the feeling of skating in streets and city plazas. The arena 10 can also include landscaping and infrastructure that simulates a true street environment, including brick walling, fountains, planters, grassy knolls, muted colors, and a well-designed city park layout. The arena 10 may also space for temporary stadium seating (not shown) and an electronic scoreboard (also not shown).

In accordance with an embodiment of the present invention, an illustrative skateboard competition (capable of being implemented in various locations that include, without limitation, an actual street location, the arena 10 described above, etc.) has a basic format that includes, without limitation, eligibility, direction, and levels. In terms of eligibility, the skateboarding competition comprises a plurality of participating competitors. There may be two to fifty competitors although the preferred number is generally around thirty competitors. However, there is no limit on the number of possible competitors, especially if the competition is open to the public. In the situation where the competitors participating in the competition are chosen beforehand by invitation-only, the number of competitors can be a more finite number (e.g., thirty two participants in an invitation-only competition). A panel of a plurality of judges will judge the competition. The panel of judges can include judges with professional skateboard competition experience, judges with only amateur skateboard competition experience, judges with no personal experience on skateboards, “celebrity” judges or the like.

The direction of competition is generally unidirectional (i.e., the skateboarding takes place in one direction only) based on the construction of the course 12. However, a particular obstacle along the course 12 may allow a competitor to move in multiple directions along or on top of the obstacle. The course 12 comprises a plurality of generally linear lanes 12 that includes one or more obstacles. Each lane 12 represents a particular level of skill and is generally skated uni-directionally (although a competitor may spend time doing various tricks at one of the obstacles along the lane). For example, the lane 12 may be skated in a generally north-to-south direction only; a generally south-to-north direction only; a generally east-to-west direction only; a generally west-to-east direction only, and so on depending on the direction orientation of the lane 12.

In terms of levels, the skateboarding competition comprises a course 12 comprising a plurality of lanes 12 in the arena 10 with each lane 12 representing a level of difficulty based upon the types of features/structures forming part of that lane 12. The number of possible levels is only limited by imagination and the physical constraints of the competition's location. Each level has its own obstacles. Competitors may start the competition on an initial lane that provides the lowest skill-level challenge. Once the competitor completes the initial lane, the competitor can move on to the next lane (which may or may not be adjacent to the initial lane) that presents a higher skill-level challenge than that of the initial level. The level of skill required by any particular course 12 is related to the design of the course 12 including any particular types of obstacles or numbers thereof. Alternatively, the course may include more than five levels or the levels may be arranged so that one or more adjacent levels may be combined as an even higher level (e.g., Level Six comprises Levels One and Two).

In general, the competitors will start each lane/level at an overall higher elevation than where the competitor finishes the lane/level. However, at various points along one or more of the lanes/levels, the competitor's elevation may temporarily increase as the competitor performs tricks and rides on various obstacles/structures positioned along the lane. One or more of the lanes may be curved with walls and ramps formed into the lane at various portions along the length of the lane although features that simulate a street or plaza environment are preferred. The lane may also be laid out in various non-linear shapes including, without limitation, an S-shape, a C-shape or the like.

In one embodiment illustrated in FIG. 1, the course 12 comprises five distinct levels of difficulty/skill (from Level One to Level Five) that includes, without limitation, Level One (a technical single trick section) 30; Level Two (a flow and bump section) 32; Level Three (a two trick line section) 34; Level Four (a medium level section) 36; and Level Five (a big obstacle section) 38. It should be noted that there need not be a linear progression of difficulty as the competitor moves from one level to the next level. That is, the next level may be rated more easy, just as easy, or less easy than the level the competitor just completed.

Level One 30, the technical single trick section, comprises a number of small skateboarding obstacles such as “ledges” and “manuals”. A “ledge” comes in the form of various structures including, without limitation, a sidewalk curb, a planter, a picnic bench or the like. The height of a “ledge” can range from anywhere from eight (8) inches for a small curb-type ledge up to over thirty five (35) inches for what would be a considered “Waist high” ledge. The average “ledge” is between sixteen (16) to twenty four (24) inches high. Ledges are used for any and all types of grinding and sliding tricks with no help from any means other than an “ollie” from the ground up onto the edge or corner of the “ledge”. The “ollie” is an aerial skateboarding trick that is also adapted to flat ground. The ollie serves as a basis for many other skateboarding tricks, such as a kickflip, a heelflip and pop-shove it. The ollie is also known as the no hands aerial, because when performing an ollie, the skateboarder does not grab the board at all, and no accessories are attached to the skateboard.

With respect to Level One 30, a “manual” has many of the same characteristics as a “ledge” in height and shape. The major difference between the “manual” and the “ledge” is that a manual is used by a skateboarder to “ollie” up onto the top and ride with either the skateboarders front or rear wheels raised off the ground in a wheelie or “manual” position which is balanced the entire length of the obstacle without allowing the wheels held off the ground to touch down. In many instances, “ledges” and “manuals” are interchangeable with the only difference being the skateboarder either does an “ollie” onto the edge/corner of the obstacle to use the obstacle for a “ledge” or the skateboarder does an “ollie” onto the top and balances on two wheels to use it as a “manual.”

In the competition format, the ledges and manuals can be used in any way a competitor chooses as long as the competitor follows the course/level uni-directionally. The competitor may accomplish a Level One run in a number of ways including, but not limited to, a set number of attempts or passes at run, as many attempts or passes as the competitor can accomplish within a set period of time, or a combination of both. For example, a competitor/rider may have one or more passes on the lane for Level One 30 with the tricks performed by the competitor individually scored with each individual trick being scored in real-time. After the rider attempts his or trick on the obstacle(s) and reaches the end of the course at the end of the lane at the bottom of the course platform, the rider returns to the top of the course platform to try again until the rider reaches the maximum number of attempts at performing a run on the lane designated for Level One 30. In another example, the rider may have a certain amount of time (e.g., five to twenty minutes, preferably ten minutes) to complete as many runs as possible on the lane of Level One 30 with the tricks performed by the competitor individually scored with each individual trick being scored in real-time. After the rider attempts his or trick on the obstacle and reaches the end of the course at the end of the lane at the bottom of the platform, the rider returns to the top of the platform to try again until the time limit is up. In any case, the rider returns to the top of the platform by walking around the edges of the course in order to avoid running into other competition making their competition runs down that same level/lane.

Level Two 32, the flow and bump section, comprises a number of “bumps” and other skateboarding obstacles that are used to propel a skateboarder into the air. A “bump” can be anything that is used to propel a rider into the air for the use of performing a trick on or over something that is too high to reach by means of a normal “ollie.” The bump can be similar to a loading dock or a sidewalk bump or anything that creates a natural bump in an urban environment. These bumps include, but are not limited to, “bump over a gap”, “bump over stairs”, “bump onto a very high (over thirty five (35) inches) “ledge”, “bump over or onto a set-up obstacle” (e.g., a picnic table or garbage can)”, “bump over a loading dock,” etc.

In the competition format, the “bump” level includes a four (4) foot raised platform that leads into a “bank” which drops down to a zero (0) foot runway which is used to propel the skateboard rider at adequate speed into the “bump” section of the level. The skateboard rider then has a choice to use the “bump” to either perform a trick up and over any obstacle (e.g., a gap, stairs, a picnic table, or any other man-made obstacle that has been set up), or to perform a trick up and onto any high “ledge,” “manual” or other man-made obstacle that has been set up. The competitor may accomplish a Level Two run in a number of ways including, but not limited to, a set number of attempts or passes at run, as many attempts or passes as the competitor can accomplish within a set period of time, or a combination of both. For example, a competitor/rider may have one or more passes on the lane for Level Two 32 with the tricks performed by the competitor individually scored with each individual trick being scored in real-time. After the rider attempts his or trick on the obstacle(s) and reaches the end of the course at the end of the lane at the bottom of the course platform, the rider returns to the top of the course platform to try again until the rider reaches the maximum number of attempts at performing a run on the lane designated for Level Two 32. In another example, the rider may have a set amount of time (e.g., five to twenty minutes, preferably ten minutes) to complete as many runs as possible on the lane of Level Two 32 with the tricks performed by the competitor individually scored with each individual trick being scored in real-time. After the rider attempts his or her trick on the obstacle and reaches the end of the course at the end of the lane at the bottom of the platform, the rider returns to the top of the platform to try again until the time limit is up. In any case, the rider returns to the top of the platform by walking around the edges of the course in order to avoid running into other competition making their competition runs down that same level/lane.

Level Three 34, the two trick line section, comprises more than one type of skate obstacle. The various types of obstacles include, but are not limited to, “ledges,” “manuals,” “bumps,” “flat bars,” “small Hubbas,” “stairs,” etc. A “flat bar” is a small “handrail” that extends straight out or slightly downward. The “flat bar” has all the same characteristics as a ledge except that the flat bar is comprised of various materials including, without limitation, metal and is two (2) to four (4) inches wide. The “flat bar” can be round or square and is used for the same purpose as the “ledge.” A “hubba” is a “ledge:” built next to a set of stairs and travels down the stairs at the same angle as the stairs and varies in height. The “hubba” has all the same characteristics as a “ledge” and is used for the same purpose.

In the competition format, the “two trick line section” comprises a four (4) foot raised platform that leads into a bank which drops down to a three (3) foot runway which is used to propel the skateboard rider at adequate speed towards the first obstacle which may be used as a “ledge” or “manual.” After the skateboard rider successfully performs a trick on the first obstacle, the competitor can then continue on and reach the second portion of the level comprising stairs having a “flat bar” and “hubbas.” The skateboard rider then must successfully perform a trick on the second obstacle of his or her choosing. Only two (2) successful tricks performed in a row will be scored by the judges. The competitor may accomplish a run in a number of ways including, but not limited to, a set number of attempts or passes at run, as many attempts or passes as the competitor can accomplish within a set period of time, or a combination of both. For example, a competitor/rider may have one or more passes on the lane for Level Three 34 with the tricks performed by the competitor individually scored with each individual trick being scored in real-time. After the rider either successfully performs his two (2) tricks or does not, and reaches the end of the course at the end of the lane at the bottom of the course platform, the rider returns to the top of the course platform to try again until the rider reaches the maximum number of attempts at performing a run on the lane designated for Level Three 34. In another example, the rider may have a set amount of time (e.g., five to twenty minutes, preferably ten minutes) to complete as many runs as possible on the lane of Level Three 34 with the tricks performed by the competitor individually scored with each individual trick being scored in real-time. After the rider completes his or her attempt to perform two (2) tricks on the obstacle (or chooses not to do so or fails at doing so) and reaches the end of the course at the end of the lane at the bottom of the platform, the rider returns to the top of the platform to try again until the time limit is up. In any case, the rider returns to the top of the platform by walking around the edges of the course in order to avoid running into other competition making their competition runs down that same level/lane.

Level Four 36, the medium section, comprises a plurality of “medium” sized skate obstacles. The obstacles may include an eight (8) to ten (10) set of stairs with one or more “handrails” going down the middle and/or sides of the stairs, a “ledge” going out off the stairs, and a “hubba.” A “handrail” is a railing that is normally used by people to hold onto as they walk down stairs. However, in skateboarding, a handrail is used as an obstacle for doing slide and grind tricks down a set of stairs. The handrail includes all the same characteristics as a “flat bar,” such as the one described above.

In the competition format, the “medium section” comprises a four (4) foot raised platform that leads directly into an eight (8) to ten (10) set of stairs having one or more “handrails” going down the middle and/or sides of the stairs, a “ledge” going straight out off the stairs, and a “hubba” going down the stairs. The competitor may accomplish a Level Four 36 run in a number of ways including, but not limited to, a set number of attempts or passes at run, as many attempts or passes as the competitor can accomplish within a set period of time, or a combination of both. For example, a competitor/rider may have one or more passes on the lane for Level Four 36 with the tricks performed by the competitor individually scored with each individual trick being scored in real-time. After the rider attempts his or her trick on the obstacle(s) and reaches the end of the course at the end of the lane at the bottom of the course platform, the rider returns to the top of the course platform to try again until the rider reaches the maximum number of attempts at performing a run on the lane designated for Level Four 36. In another example, the rider may have a set amount of time (e.g., five to twenty minutes, preferably ten minutes) to complete as many runs as possible on the lane of Level Four 36 with the tricks performed by the competitor individually scored with each individual trick being scored in real-time. After the rider attempts his or her trick on the obstacle and reaches the end of the course at the bottom of the platform, the rider returns to the top of the platform to try again until the time limit is up. The rider returns to the top of the platform by walking around the edges of the course in order to avoid running into other competition making their competition runs down that same level/lane.

Level Five 38, the big section, comprises a plurality of “big” sized skate obstacles and includes a twelve (12) to sixteen (16) set of stairs and one or more “handrails” going down the middle or sides of the stairs. The “big section” comprises a six (6) foot raised platform that leads directly into a twelve (12) to sixteen (16) set of stairs with a “handrail” going down the middle and/or sides of the stairs. Level Five 38, in a five level course, is generally the Final level. Alternatively, Level Five 38 may be comprised of one or more of the lanes or a combination of the lanes and the platform described above. The competitor may accomplish a Level Five 38 run in a number of ways including, but not limited to, a set number of attempts or passes at run, as many attempts or passes as the competitor can accomplish within a set period of time, or a combination of both. For example, a competitor/rider may have one or more passes on the lane for Level Five 38 with the tricks performed by the competitor individually scored with each individual trick being scored in real-time. After the rider attempts his or her trick on the obstacle(s) and reaches the end of the level at the bottom of the platform, the rider returns to the top of the platform to try again until the rider reaches the maximum number of attempts at performing a run on the lane designated for Level Five 38. In another example, the rider may have a set amount of time (e.g., five to twenty minutes, preferably ten minutes) to complete as many runs as possible on the lane of Level Five 38 with the tricks performed by the competitor individually scored with each individual trick being scored in real-time. After the rider attempts his or her trick on the obstacle and reaches the end of the course at the bottom of the platform, the rider returns to the top of the platform to try again until the time constraint is up. The rider returns to the top of the platform by walking around the edges of the course in order to avoid running into other competition making their competition runs down that same level/lane.

In use, the competition is based upon timing and competitor scoring. The competition starts out with, for example, thirty-two (32) competitors in at least one Qualifying round who are competing for eight (8) coveted spots in a Final round. The competitor may accomplish the Semi-Finals or Qualifying in a number of ways including, but not limited to, a set number of attempts or passes at the run(s), as many attempts or passes as the competitor can accomplish within a set period of time, or a combination of both. For example, each competitor/rider may have one or more passes on the Semi-Finals or Qualifying with the tricks performed by the competitor individually scored with each individual trick being scored in real-time. The competitors can do their runs individually one-at-a-time or in jam-style format. The Qualifying round comprises eight (8) competitors skateboarding for a set number of runs on, for example, two (2) of the four (4) levels (e.g., Levels One & Four 30, 36 and Levels Two & Three 32, 34, Levels One & Three 30, 34 and Levels Two & Four 32, 36, or any imaginable combination of levels). Alternatively, the competitors have a set number of runs on any possible combination/permutation of levels. After the rider attempts his or trick on the obstacle(s) and reaches the end of the course, the rider returns to the top of the course to try again until the rider reaches the maximum number of attempts for the Semi-Finals or Qualifying. In another example, the rider may have a certain amount of time (e.g., half an hour to two hours overall broken down into ten minute time intervals) to complete Semi-Finals or Qualifying round comprising eight (8) competitors (individually one-at-a-time or in jam-style format) skateboarding in set time intervals (e.g., ten minutes) on two (2) of the four (4) levels (e.g., Levels One & Four 30, 36 and Levels Two & Three 32, 34, Levels One & Three 30, 34 and Levels Two & Four 32, 36, or any imaginable combination of levels).

As mentioned above, no matter whether the competitor has a set number of attempts or passes at the run(s), as many attempts or passes as the competitor can accomplish within a set period of time, or a combination of both, the competitors can compete individually or in a “jam” style format. A jam-style format is an open forum for all skaters and riders to compete together. The jam-style format is intended to encourage the competitors to try various maneuvers and tricks. However, the jam-style format is less preferred given the drawbacks associated with the jam-style format, such as collision between competitors, tricks being missed by judges in the confusion, etc. Each skateboard rider is scored for each level based on his or her performance and the scores are tallied. The top eight (8) combined scores from each session qualify for the Finals. The lowest score for any of the four (4) sections is thrown out leaving three (3) scores for each competitor which are combined and averaged to find the top eight (8) scores out of the thirty two (32). The number of initial competitors in the Qualifying rounds may be more or less than thirty two (32). Likewise, the number of initial competitors in the Final round may be more or less than eight (8). As mentioned above, the Qualifying round may use any permutation or combination of Levels One, Two, Three and Four 30-36. Level Five 38 (or its equivalent if more than five levels are used during the competition) is usually reserved as the “final” level.

During the first part of the Final round, the eight (8) finalists skate (either individually one-at-a-time or in a “jam” style format) a set number of attempts or passes at the run(s), as many attempts or passes as the competitor can accomplish within a set period of time (e.g., ten (10) minute time intervals) or a combination of both on two (2) of the four (4) levels (e.g., Levels One & Four 30, 36 and Levels Two & Three 32, 34, Levels One & Three 30, 34 and Levels Two & Four 32, 36, or any imaginable combination of levels). Each rider is scored for each level based on his or her performance and the scores are tallied. The lowest score for any of the four (4) levels/sections is thrown out leaving three (3) scores for each competitor which are combined and averaged to find the top eight (8) scores for the four (4) sections and the eight (8) finalists ranked accordingly.

During the second part of the Final round, the eight (8) finalists skate (either individually one-at-a-time or in a “jam” style format) the final section, Level Five 38, for a set number of attempts or passes at the run(s), as many attempts or passes as the competitor can accomplish within a set period of time (e.g., ten (10) minute time intervals) or a combination of both. Each skateboard rider is scored based on his or her performance (in real-time on a trick-by-trick basis) and the scores are tallied. The combined average score from Levels One to Four 30-36 and the score from Level Five 38 are combined and averaged. The final, highest score determines the overall winner.

The competition may end in a climactic “big obstacle” section. Usually, this section includes a set of sixteen stairs and accompanied handrail for the professional skaters to skate. This type of obstacle is known as one of the most feared and impressive type of obstacles within the world of professional street skating. By leaving the most dangerous and exciting section to the Finals only, a “limitless slam dunk” dynamic is created for the climax of the competition to produce moments of glory, pain, and overall magic that the category of street skating is known for.

In accordance with an embodiment of the present invention, scoring is an integral part of the competition. It is preferred to incorporate a real-time, instant scoring system into the competition. In one illustrative embodiment, the scoring system includes hand-held devices having dials that will be used by the judges to continuously, and instantaneously, evaluate every trick, run and element as well as an athlete or competitor's overall performance. The hand-held dials allow judges privacy in scoring an competitor. Software is used to program the system, capture individual responses, and analyze data. The privacy the dials offer allows judges to score more honestly and minimizes the impact of groupthink. With results immediately available, competitors can respond quickly to “bring up their game” and push themselves to their limits. The software is flexible enough to export data to analytic software of choice so that both competitors and audience members have the latest statistics for any one of the competitors. The judges turn their respective dials a desired amount to indicate a particular score. The judges can dial low scores, high scores or in-between scores. The system may include a console to wirelessly communicate between the dials and the computer system the hand-held devices are operationally connected to. The hand-held devices may also be connected to the console by wires. The computer system runs software designed to translate the dialed score into graphics on an electronic scoreboard operationally connected (e.g., wired or wirelessly) to the computer system. This software-based judging system allows for real-time instant allocation of points for each trick that is landed. This enables television viewers and the live audience to see exactly what the judges are reacting to in real-time, dramatically enhancing the viewing impact and entertainment experience. The dial provides the instant response required for a live, real-time, trick-by-trick, run-by-run scoring system. With real-time scoring, suspense can be built with close scoring between competitions creating intense competition that builds the potential for a buzzer beating finale. This scoring system provides street skaters with a connection between their competitive achievement and the parallel emotional experience fans have while watching the competition at a live event or on television. Although the fast action tricks, falls, and impressive nature of street skating is naturally exciting, many non-participating spectators may not know the exact value and merit of each trick performed during a contest.

The scoring system shows exactly where each skater stands against each other during the actual contest. In current skate contests, the ranking and score of each skater remains a complete mystery until the contest is over. This hurts the viewer's experience of the event and lessens the professional skater's ability to know where he or she stands against the competition. As a result, the illustrative scoring system adds value to both the viewer and the professional skateboarder participating in the event by providing constant understanding of the points being scored, and real-time knowledge of who is leading, and how many points the underdog needs to score to win. The scoring can be displayed not only on the scoreboard (e.g., a jumbotron) in the arena 10 but also directly on a television broadcast, satellite broadcast or webcast of the competition.

As outlined above, in accordance with an embodiment of the present invention, the scoring system brings sports statistics to street skateboarding for the first time. Much like the real-time scoring, “street stats” give the spectator unmatched insight to the different dynamics within the category of street skateboarding. Much of these statistics will be based on the percentage of tricks completed (or “landed” as described in the street skating world). These “land percentages” are unique. Examples of street stats include: overall land percentage (i.e., consistency rating); switch stance land percentage; ledge trick land percentage; handrail land percentage; number of NBD's to-date (i.e., the number of tricks performed by the skater that have Never Been Done (NBD) before); longest land streak to-date (i.e., amount of back-to-back tricks landed in a row); overall skater rating (i.e., combining all performance measures, much like a quarterback rating) and the like. These street stats bring another element to the competition that will excite the spectator while organizing and helping the sport of skateboarding as a whole. Specifically, it provides statistical analysis to help the audience understand the strengths and weaknesses of each individual skater.

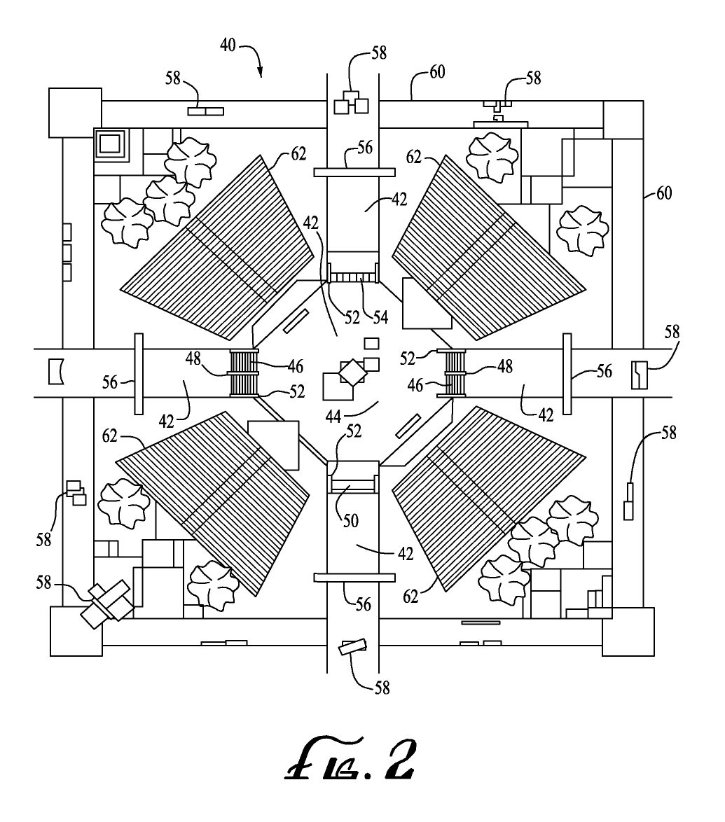

As seen in FIG. 2, an illustrative skateboarding competition skate plaza or arena 40 in accordance with an embodiment of the present invention includes a “circular” plaza to give every audience member an equal view on the action without having to sacrifice the key lane-based format. A course 42 is illustrated that comprises a plurality of generally linear lanes (e.g., four (4) lanes are illustrated but the number of lanes may be as few as one and as many as the size of the arena 40 will allow) with each lane corresponding to a distinct, skateboarding skill level and are generally arranged at ninety (90) degree angles to the next lane (i.e., when four (4) lanes are used). The angle between each generally linear lane depends on the total number of lanes used (e.g., if eight lanes (8) form part of the course 42, the lanes may be at forty five (45) degree angles to one another). Each lane generally runs from an outer part of the arena 40 in towards a central section 44. The arena 40 is similar to the arena 10 described above in that the arena 40 simulates a number of environments (e.g., a street corner environment; a corner park environment; the environment outside of an office building that includes various obstacles that include, without limitation, steps (e.g., broad wide steps, short narrow steps, etc.) 46, handrails (e.g., metal railing, concrete or stone handrails, etc.) 48 with the handrails 48 on the sides of the steps 46 or running down the middle of the steps 46, landscaping 50 (e.g., trees, flower beds, shrubs, planters, hedges or the like), concrete ledges 52, water fountains 54, ramps or the like) that can be found in any urban or suburban area. The arena 40 gives the impression that a skateboard competitor is in a public square or courtyard in a downtown, urban area. The central section 44 may include a number of the foregoing obstacles. The arena 40 includes a number of electronic scoreboards 56 with each lane straddled by at least one scoreboard 56 so as to be viewable by competitor and spectator alike. The scoreboard 56 is operationally connected to a scoring system, such as the one described above. A number of miscellaneous obstacles 58 of various designs, such as those described above and below, may be scattered about a periphery section 60 of the arena 40. The periphery section 60 may be used as part of the course 42 and a competitor may use an obstacle 58 on a competition lane as part of the competition (e.g., as a starting point for a run or heat). The arena 40 includes at least one stadium seating stand (e.g., temporary or permanent) 62 though several stands 62 are illustrated in FIG. 2 as being arranged around the central section 44 of the arena 40 with the competition lanes of the course 42 disposed between the stands 62.

The competition levels 30-38 described above may be adapted for use with the arena 40. For example, each of the four lanes of the course 42 can be assigned a particular level (e.g., Level One to one lane, Level Two to another lane, etc.) and the lanes need designated a particular level in any set manner. For example, Level Two could be adjacent to Level Four but opposite of the central section to Level One. The central section 44 of the arena 40 may be used as part of any one or more of the levels 30-38, serve as part of a competition level in its own right or the like. For example, the central section 44 can be assigned to be Level Five, with obstacles placed in the central section and/or also incorporating obstacles from the portions of the lanes adjacent the central section 44.

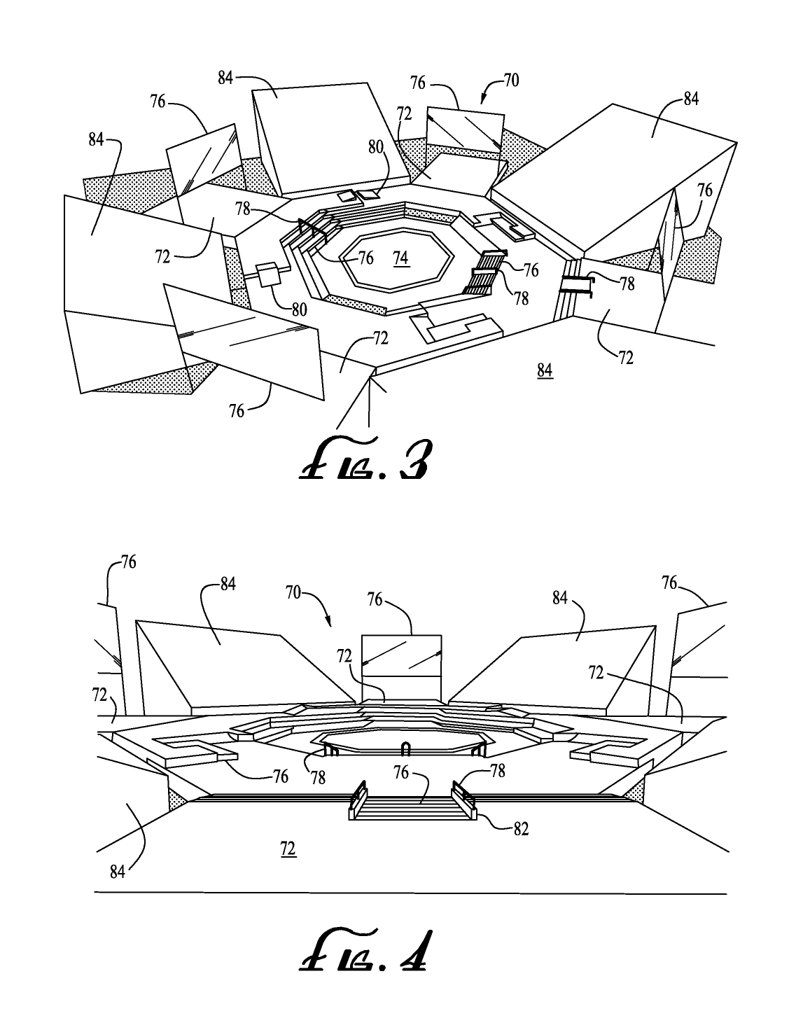

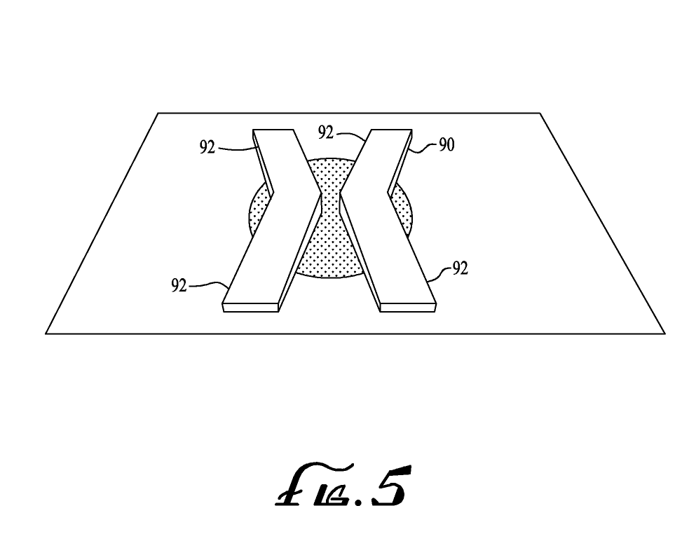

Another embodiment of an illustrative skateboarding competition skate plaza or arena 70 in accordance with the present invention is shown in FIGS. 3 and 4. The arena 70 is similar to the arena 40 described above in that the arena 70 is generally in the form of a “circular” plaza that gives every audience member an equal view on the action without having to sacrifice the lane-based format. A course 72 is illustrated that comprises a plurality of generally linear lanes (e.g., four (4) lanes are illustrated but the number of lanes may be as few as one and as many as the size of the arena 70 will allow) with each lane corresponding to a distinct, skateboarding skill level and are generally arranged at ninety (90) degree angles to the next lane (i.e., when four (4) lanes are used). The angle between each generally linear lane depends on the total number of lanes used (e.g., if eight lanes (8) form part of the course 72, the lanes may be at forty five (45) degree angles to one another). Each lane generally runs from an outer part of the arena 70 in towards a central section 74. The arena 70 is similar to the arenas 10, 40 described above in that the arena 70 simulates a number of environments (e.g., a street corner environment; a corner park environment; the environment outside of an office building that includes various obstacles that include, without limitation, steps (e.g., broad wide steps, short narrow steps, etc.) 76, handrails (e.g., metal railing, concrete or stone handrails, etc.) 78 with the handrails 78 on the sides of the steps 76 or running down the middle of the steps 76, landscaping (e.g., trees, flower beds, shrubs, planters, hedges or the like), ramps 80 (alone or as part of a pair arranged with a gap there between for a competitor to jump the gap between the ramps 80), concrete ledges 82 (with or without railing on top of the ledges 82), water fountains or the like that can be found in any urban or suburban area. The arena 70 gives the impression that a skateboard competitor is in a public square or courtyard in a downtown, urban area. The central section 74 may include a number of the foregoing obstacles (either permanent or temporary). The arena 70 includes a number of electronic scoreboards 76 with each lane straddled by at least one scoreboard 76 so as to be viewable by competitor and spectator alike. The scoreboard 76 is operationally connected to a scoring system, such as the one described above. The arena 70 includes at least one stadium seating stand (e.g., temporary or permanent) 84 though several stands 84 are illustrated in FIGS. 3 and 4 as being arranged around the central section 74 of the arena 70 with the competition lanes of the course 72 disposed between the stands 84.

The competition levels 30-38 described above may be adapted for use with the arena 70. For example, each of the four lanes of the course 72 can be assigned a particular level (e.g., Level One to one lane, Level Two to another lane, etc.) and the lanes need designated a particular level in any set manner. For example, Level Two could be adjacent to Level Four but opposite of the central section to Level One. The central section 74 of the arena 40 may be used as part of any one or more of the levels 30-38, serve as part of a competition level in its own right or the like. For example, the central section 74 can be assigned to be Level Five, with obstacles placed in the central section and/or also incorporating obstacles from the portions of the lanes adjacent the central section 74.

Important in the design of the arenas 10, 40, 70 is the goal of creating skate obstacles that embrace the authenticity of real street design that provides an opportunity for skateboarders to do tricks that have never been done before. An example of this type of design can be seen in FIG. 5 with an X-shaped obstacle 90 that allows for trick combinations and complex skateboarding that has yet to be seen in the sport of skateboarding. Each branch 92 of the obstacle 90 is illustrated as tapering downwardly towards its distal end. However, the branches 92 may provide a level surface or each branches 92 may taper upwardly towards its distal end.

The various arena embodiments described above are just illustrations the many possibilities available for a competition arena. Alternatively, the lanes of an arena can be arranged on scaffolding or set up at various heights and angles with respect to one another. Also, the lanes may be set up so that they create the appearance of a “switchback trail” with the skater starting the first lane at a particular height and then descending towards the next lane.

Alternatively, various structures may be positioned along one or more of the lanes described above. These structures include, but are not limited to, at least one half-pipe, at least one quarter pipe, one or more handrails, one or more trick boxes, one or more vert ramps, one or more pyramids, one or more banked ramps, one or more full pipes, one or more stairs, and any number of other trick-oriented objects.

Additional embodiments of the present invention may be made by combining various elements of one of the above-described embodiments with various elements of another one or more of the above-described embodiments.

The following claims are thus to be understood to include what is specifically illustrated and described above, what is conceptually equivalent, what can be obviously substituted and also what essentially incorporates the essential idea of the invention. Those skilled in the art will appreciate that various adaptations and modifications of the just-described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

I claim:

1. A skateboard arena simulating an urban landscape, comprising:
a course including a number of structures used for skateboarding tricks; and
means for electronic real-time scoring of skateboarding tricks performed by a competitor during at least one run on the course;
wherein each structure simulates a feature of an urban landscape.

2. The skateboard arena of claim 1, wherein the course comprises a plurality of lanes, each lane represents a level of skateboarding difficulty and includes a number of the structures used for skateboarding tricks; wherein no two lanes are identical.

3. The skateboard arena of claim 2, wherein each lane generally runs from a higher elevation to a lower elevation.

4. The skateboard arena of claim 2, wherein each lane is generally linear.

5. The skateboard arena of claim 2, wherein each lane is at an angle relative to a neighboring lane.

6. The skateboard arena of claim 2, wherein at least two lanes represent a level of skateboarding difficulty.

7. The skateboard arena of claim 2, wherein the lanes flow into a common section representing a level of skateboarding difficulty.

8. The skateboard arena of claim 1, wherein the structures include at least one of ledges, manuals, handrails, stairs, flat bars and hubbas.

9. The skateboard arena of claim 1, wherein each skateboarder is scored individually in real-time during the at least one run.

10. The skateboard arena of claim 1, wherein each individual trick performed during the at least one run is scored real-time.

11. The skateboard arena of claim 1, wherein scoring is displayed in real-time.

12. A method for a skateboard competition, comprising:
starting with a plurality of competitors in a qualifying round;
electronically scoring each competitor in real-time based on tricks performed;
determining the competitors for a final round;
electronically scoring the final round competitors in real-time based on tricks performed;
declaring a winner of the competition.

13. The method of claim 12, comprising setting the skateboard competition in an arena simulating an urban landscape.

14. The method of claim 12, wherein the electronically scoring step includes displaying scoring in real-time.

15. The method of claim 12, wherein the electronically scoring step includes scoring each individual trick in real-time.

16. The method of claim 12, comprising performing tricks using a structure simulating a feature of an urban landscape.

17. The method of claim 12, wherein the determining step includes eliminating all but a range of the highest scoring competitors.
